(19) United States
(12) Patent Application Publication
(10) Pub. No.: US 2009/0122086 A1
(43) Pub. Date: May 14, 2009

(54) LIGHT CONTROL PICTURE FRAME

(76) Inventors: Elmo M.A. Diederiks, Eindhoven (NL); Martijn A.B. Santbergen, Delft (NL); Srinivas V.R. Gutta, Veldhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 11/577,759

(22) PCT Filed: Oct. 24, 2005
(86) PCT No.: PCT/IB05/53472

§ 371 Date: Apr. 23, 2007

Related U.S. Application Data
(60) Provisional application No. 60/621,869, filed on Oct. 25, 2004.

(51) Int. Cl. G09G 5/10

(52) U.S. Cl. 345/690

(57) ABSTRACT

A light control picture frame system and method including a processor (300) responsive to a user input signal (350), generating a display signal (352), and generating a transmitter signal (354); a picture frame display (304) responsive to the display signal (352); a user input device (312) generating the user input signal (350) responsive to a user; and a light signal transmitter (308) responsive to the transmitter signal (354).

The present invention relates generally to light unit controllers, and more particularly, to a system and method for controlling a light unit with a light control picture frame.

Sophisticated light units, such as those that support mood lighting, are becoming increasingly popular. Many light units include different types of lights so that each of the individual lights within the light unit can be set to create an overall lighting effect or ambiance. The individual lights can be set to specific color and intensity settings for a desired lighting effect. Remote controls or personal computers are often used to specify the individual settings for individual lights. Remote controls are easily misplaced and personal computers are bulky and inconvenient to use, inconveniencing the user.

Existing light units can include a number of pre-defined light unit settings to create a number of lighting effects, but the customization options available to create a customized look are often limited. The desired setting for each individual light must be provided. Creating customized light unit settings often requires costly professional assistance.

It would be desirable to have a light control picture frame that would overcome the above disadvantages.

One aspect of the present invention provides a light control picture frame including a processor responsive to a user input signal, generating a display signal, and generating a transmitter signal; a picture frame display responsive to the display signal; a user input device generating the user input signal responsive to a user; and a light signal transmitter responsive to the transmitter signal.

Another aspect of the present invention provides a method of light unit control, the method including providing a picture frame display, displaying a color index on the picture frame display, selecting a color scheme from the color index, and generating a light control signal in response to the color scheme.

Another aspect of the present invention provides a system for controlling a light unit including a picture frame display, means for displaying a color index on the picture frame display, means for selecting a color scheme from the color index, and means for generating a light control signal in response to the color scheme.

Another aspect of the present invention provides a method for controlling a light unit including providing a picture, sampling a characteristic of the picture, and generating a light control signal in response to the characteristic.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

Various embodiments of the present invention are illustrated by the accompanying figures, wherein:

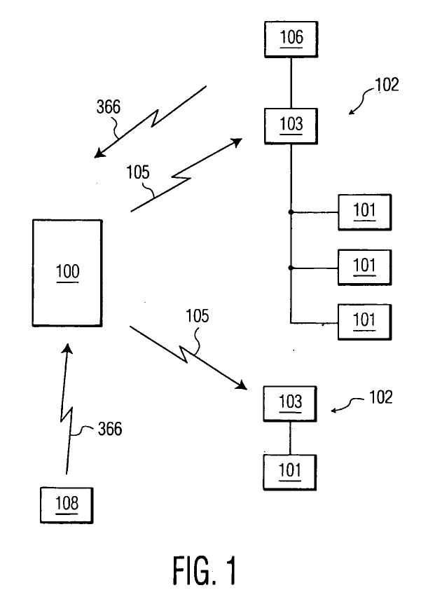

FIG. 1 is a block diagram of a light system employing a light control picture frame made in accordance with the present invention;

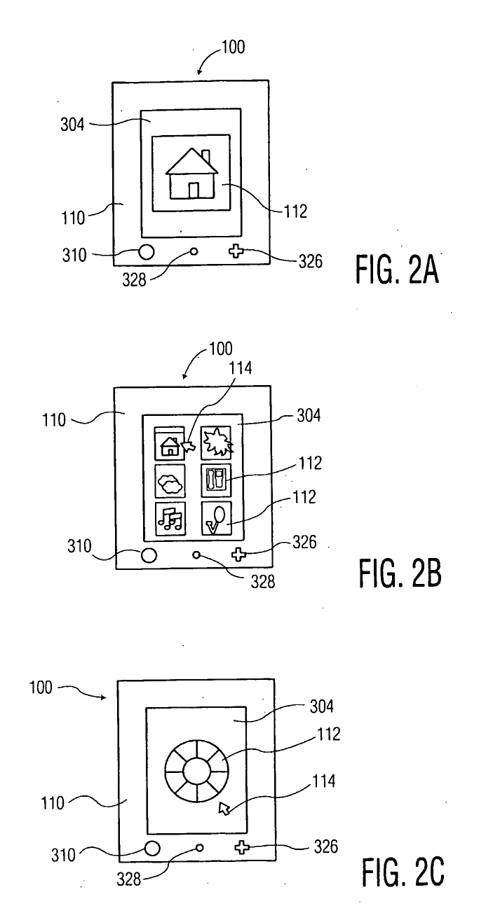

FIGS. 2A-2C are schematic diagrams of light control picture frame modes for a light control picture frame made in accordance with the present invention;

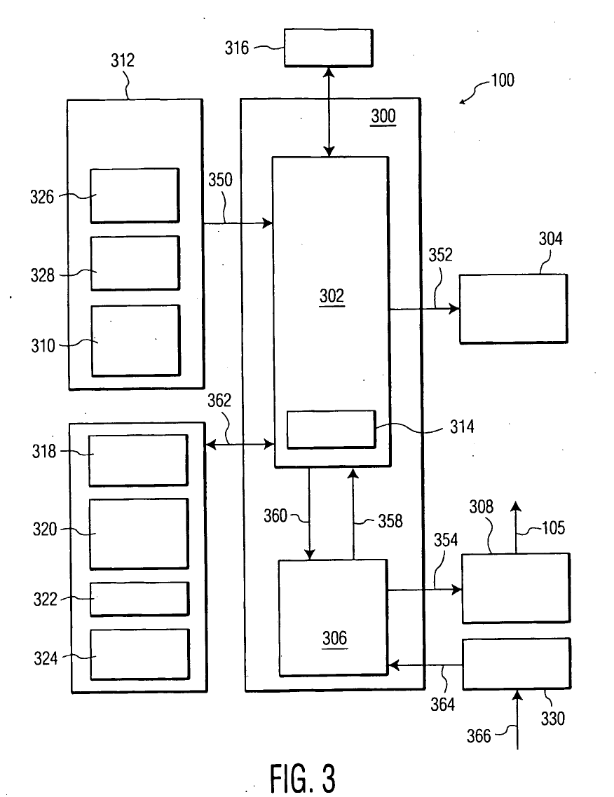

FIG. 3 is a block diagram of a light control picture frame made in accordance with the present invention;

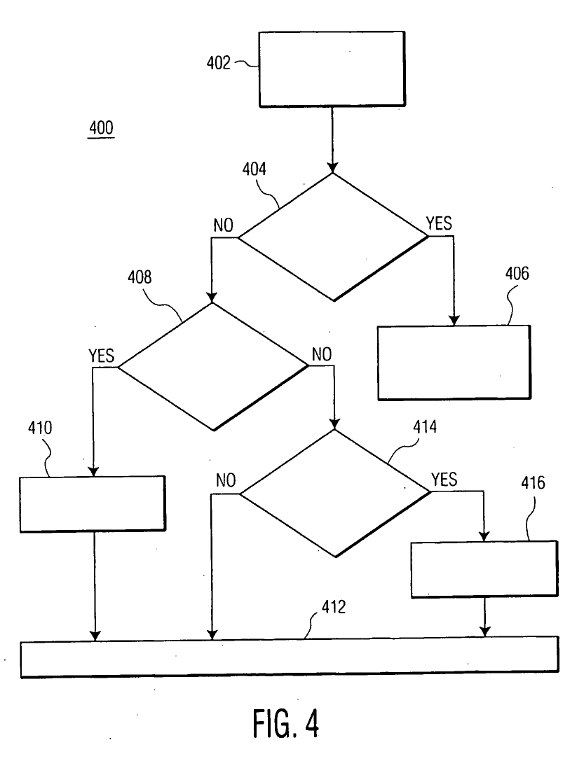

FIG. 4 is a flow chart of a method of selecting a light control picture frame mode for a light control picture frame made in accordance with the present invention; and

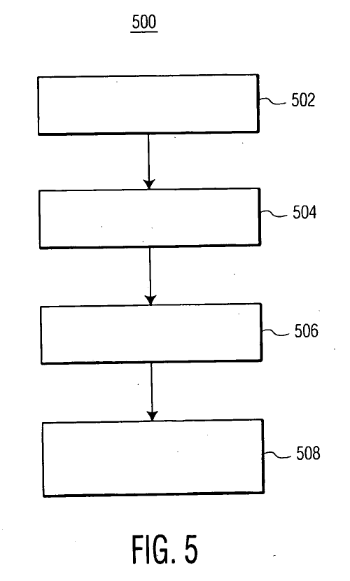

FIG. 5 is a flow chart of a method of controlling a light unit using a light control picture frame made in accordance with the present invention; and

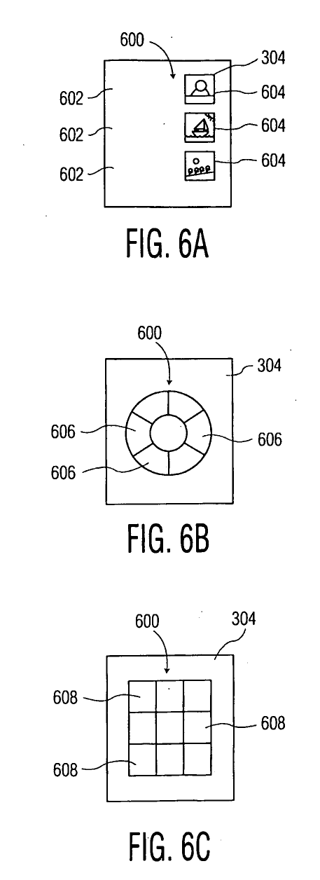

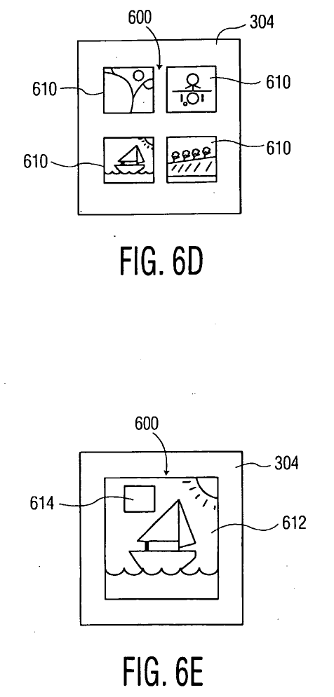

FIGS. 6A-6E are schematic diagrams of color indexes for a light control picture frame made in accordance with the present invention.

FIG. 1 is a block diagram of a light system employing a light control picture frame made in accordance with the present invention. A light control picture frame 100 allows the user to control lights 101 and to display a digital picture on the light control picture frame 100. The light control picture frame 100 communicates with one or more light units 102 over light control signal 105 to control the color and/or intensity of the lights 101 within the light unit 102 responsive to a user selected color scheme. In the example shown, light unit receiver 103 receives the light control signal 105 and controls lights 101. In one embodiment, the light control picture frame 100 is responsive to a frame control signal 366.

The light unit 102 includes a light unit receiver 103 responsive to the light control signal 105 and lights 101 having color settings and/or intensity settings. The light unit 102 includes at least one light 101, but can have as many as desired. In one embodiment, each light 101 has adjustable color and intensity, controllable by the light control picture frame 100. In an alternative embodiment, the light unit 102 includes a number of lights 101, which can be identical or can be of different types, having different power, intensity, color, shape, or the like. A number of light units 102 controlled from a single light control picture frame 100 can be provided within a room to allow various lighting designs. In one embodiment, the light unit 102 includes an optional light unit transmitter 106 generating a frame control signal 366.

The light control signal 105 controls intensity and/or color of the lights 101 in the light unit 102. In one embodiment, the light control signal 105 can switch power to selected lights 101 of the light unit 102 to turn the lights 101 on and off. The light control signal 105 can be directional so that the light control picture frame 100 can be pointed at a specific light unit 102 when there is more than one light unit, or can be wide-angle to reach a number of light units 102 at once.

The light control signal 105 is any signal suitable for transferring information between the light control picture frame 100 and the light unit 102. In one embodiment, the light control signal 105 is a photonic signal in the frequency range from infrared to ultraviolet light. In an alternative embodiment, the light control signal 105 is a radio signal. In another alternative embodiment, the light control signal 105 is a power line signal and the light control picture frame 100 communicates with the light unit 102 over power lines connected to the light unit 102. In another alternative embodiment, the light control picture frame 100 is wired to the light unit 102 and the light control signal 105 is a wired signal. The light control signal 105 can conform to a standard lighting control protocol, such as a digital addressable lighting interface (DALI) or ZigBee protocol.

The light control picture frame 100 can be responsive to an optional frame control signal 366. The frame control signal 366 can be a command or information signal provided by a light unit transmitter 106, or by a building or area lighting control system 108. The frame control signal 366 can conform to a standard lighting control protocol, such as a digital addressable lighting interface (DALI) or ZigBee protocol. In one embodiment, the frame control signal 366 is a photonic signal in the frequency range from infrared to ultraviolet light. In an alternative embodiment, the frame control signal 366 is a radio signal. In another alternative embodiment, the frame control signal 366 is a power line signal. In another alternative embodiment, the frame control signal 366 is wired to the signal source and the frame control signal 366 is a wired signal.

FIG. 2A-2C are schematic diagrams of light control picture frame modes for a light control picture frame made in accordance with the present invention. In one example, the light control picture frame 100 can be placed in three light control picture frame modes: a picture display mode, a display control mode, and a light control mode. The exemplary light control picture frame 100 includes a support frame 110 surrounding a picture frame display 304, such as a liquid crystal display (LCD), an e-ink display, an organic light-emitting diode display (OLED), a polymer light-emitting diode display (PolyLED), a touch screen display, or the like. The picture frame display 304 displays visual information 112. In one embodiment, the light control picture frame 100 includes user input devices, such as a mode selection control 310 for switching among the light control picture frame modes, a cursor control 326 for maneuvering a cursor 114 on the picture frame display 304, and/or a option selection control 328 for making a selection from the visual information displayed on the picture frame display 304.

FIG. 2A illustrates the light control picture frame 100 in the picture display mode. A digital picture is the visual information 112 displayed on the picture frame display 304. The digital picture is selected by the user from user or commercially provided images stored in the light control picture frame 100.

FIG. 2B illustrates the light control picture frame 100 in the display control mode. Digital pictures for selection, various commands, and options for particular modes are the visual information 112 displayed on the picture frame display 304. The user manages the display and operation of the light control picture frame 100 in the display control mode. Examples of operations available in the display control mode include defining the display parameters of the picture frame display 304, downloading digital pictures from an external source into the memory 316, selecting digital pictures for display in the picture frame display 304, and selecting a number of digital pictures for display in the picture frame display 304 in a slide show format. The display parameters of the picture frame display 304 can be provided in a display options menu. Examples of the display parameters include display contrast, display brightness, display sharpness, display tint and display color. The ranges of the selected display parameter can also be displayed on the picture frame display 304.

FIG. 2C illustrates the light control picture frame 100 in the light control mode. A color index is the visual information 112 displayed on the picture frame display 304. The user selects a color scheme from the color index to control operation of the light unit.

FIG. 3 is a block diagram of a light control picture frame made in accordance with the present invention. The light control picture frame 100 includes a user input device 312, a processor 300, a picture frame display 304, a memory 316, and a light signal transmitter 308. The processor 300 has a display controller 302 and a light controller 306. The display controller 302 can optionally include a sampler 314. The user input device 312 includes a cursor control 326, an option selection control 328, and a mode selection control 310. In various embodiments, the light control picture frame 100 optionally includes a digital camera interface 318, a digital memory card interface 320, a modem 322, a printer interface 324, and/or a frame receiver 330. The user input device 312 provides input from the user to the processor 300, which controls the display of visual information on the picture frame display 304 and communication with the light unit through the light signal transmitter 308.

The user input device 312 provides a user input signal 350 to the display controller 302 of the processor 300 to allow the user to control the light control picture frame 100 and the light unit through the light control picture frame 100. In the example shown, the user input device 312 includes a cursor control 326, an option selection control 328, and a mode selection control 310. The user input device 312 can be a physical device and/or the picture frame display 304 itself, displaying options for user selection.

The cursor control 326 allows the user to move a cursor around the picture frame display 304. The cursor control 326 can be any mechanical, optical or optomechanical device for maneuvering a cursor or pointer, such as one or more knobs, a touchpad, a roller ball, or the like.

The option selection control 328 allows the user to make a selection from the visual information displayed on the picture frame display 304. The option selection control 328 can be any mechanical, optical or optomechanical device indicating user contact, such as a pushbutton, a touchpad, a capacitive switch, an optical switch, or the like.

The mode selection control 310 allows the user to switch the light control picture frame 100 among the light control picture frame modes. The mode selection control 310 can be any mechanical, optical or optomechanical device for indicating user selection, such as a knob, a touchpad, one or more capacitive switches, one or more optical switches, or the like. In one embodiment, the mode selection control 310 is a mode selection knob where a mode is selected based on the rotary position of the mode selection knob.

In an alternative embodiment, the cursor control 326 acts as the mode selection control 310. The cursor control 326 is used to position a cursor over the desired light control picture frame mode on the mode selection menu displayed on the picture frame display 304. The position of the cursor on the picture frame display 304 can be used to select the desired light control picture frame mode from a mode selection menu by the user maintaining the cursor over the desired light control picture frame mode, or the user can “click” on the desired light control picture frame mode from the mode selection menu with the option selection control 328. In another alternative embodiment, the picture frame display 304 is a touch screen and the mode selection control 310 is the picture frame display 304. The user touches the desired light control picture frame mode on a mode selection menu displayed on the picture frame display 304 to select the desired light control picture frame mode.

Those skilled in the art will appreciate that cursor control 326, option selection control 328, and mode selection control 310 can be combined into a single control device, such as a multifunction touchpad. One or more of the cursor control 326, option selection control 328, and mode selection control 310 can be omitted as desired for a particular application. In one embodiment, the picture frame display 304 is a touch screen display, such as a resistive touch screen, a capacitive touch screen, a surface acoustic wave touch screen, or the like, and the user input device 312 is the picture frame display 304. The user provides input by touching the picture frame display 304 to choose from options or to move a cursor displayed on the picture frame display 304.

The picture frame display 304 receives a display signal 352 from the display controller 302 of the processor 300 to display visual information to the user. The picture frame display 304 can be any display device, such as a liquid crystal display (LCD), an e-ink display, an organic light-emitting diode display (OLED), a polymer light-emitting diode display (PolyLED), a touch screen display, or the like. The display signal 352 is typically a flat surface display, but can have other geometries as desired. The picture frame display 304 displays a digital picture when the light control picture frame 100 is in picture display mode and a graphical user interface (GUI) when the light control picture frame 100 is in display control mode or light control mode. A cursor can also be displayed on the picture frame display 304 to point to desired selections on the GUI. The picture frame display 304 can be surrounded by a support frame (not shown). The support frame can also enclose the components of the light control picture frame 100 and provide decorative elements. In one embodiment, the picture frame display 304 is a resistive touch screen, a capacitive touch screen, a surface acoustic wave touch screen, or the like, so that the picture frame display 304 incorporates the user input device 312.

The light signal transmitter 308 receives a transmitter signal 354 from the light controller 306 and provides a light control signal 105 to the light unit 102. The light signal transmitter 308 can be any transmitter suitable for converting the transmitter signal 354 to the light control signal 105, which is typically a wireless signal such as a photonic or radio signal.

The processor 300 coordinates the functions of the light control picture frame 100 and includes a display controller 302 and a light controller 306. The light controller 306 provides a display control signal 358 to the display controller 302 and the display controller 302 provides a color scheme signal 360 to the light controller 306. The processor 300 receives the user input signal 350 from the user input device 312, provides the display signal 352 to the picture frame display 304, and provides the transmitter signal 354 to the light signal transmitter 308. The processor 300 can be a general purpose or dedicated processor performing the functions of the display controller 302, light controller 306, and other functions under software control. Memory 316, which communicates with the display controller 302 of the processor 300 with memory signal 356, stores software instructions for the processor 300 and data including digital pictures for display on the picture frame display 304. The memory 316 can be RAM, ROM, optical storage, magnetic storage, or combinations thereof. Those skilled in the art will appreciate that more than one processor can be used to perform the various functions of the exemplary processor 300. For example, the display controller 302 can run on one processor and the light controller 306 can run on a different processor.

The display controller 302 coordinates the display of visual information on the picture frame display 304. In the picture display mode, the display controller 302 coordinates the display of digital pictures in the picture frame display 304. In the display control mode, the display controller 302 coordinates display of control options, such as defining the display parameters of the picture frame display 304, downloading digital pictures from an external source into the memory 316, and selection of digital pictures for display in the picture frame display 304. In the light control mode, the display controller 302 coordinates display of a color index in the picture frame display 304 and generates a color scheme signal 360 responsive to the color scheme selected from the color index.

In one embodiment, the display controller 302 of the processor 300 includes an optional sampler 314. The sampler 314 assesses the characteristics of a digital picture or a selected portion of a digital picture by sampling characteristics of the digital picture or the selected portion to determine an associated color scheme. Examples of characteristics include color, brightness, intensity, hue, saturation, luminosity, or the like. The digital memory can be retrieved from the memory 316. The display controller 302 generates a color scheme signal 360 based on the color scheme determined by the sampler 314.

In one embodiment, the sampler 314 analyzes the characteristics of pixels within the selected portion of the picture lying within an identified grid. The picture frame display 304 is divided into a number of grids. When a portion of a picture is selected, the display controller 302 identifies the grid associated with the selected portion of the picture. When the selected portion of the picture overlies multiple grids, the grid containing the largest section of the selected portion of the picture is identified.

The light controller 306 receives the color scheme signal 360 and responsively generates a transmitter signal 354. The light signal transmitter receives the transmitter signal 354 and generates the light control signal 105. The light control signal 105 adjusts the light settings in the light unit 102 to create an overall lighting effect that reflects the selected color scheme.

In one embodiment, the light controller 306 of the processor 300 receives a receiver signal 364 from an optional frame receiver 330, which receives a frame control signal 366. The frame control signal 366 can be a command or information signal provided by a light unit, or by a building or area lighting control system. The frame control signal 366 can conform to a standard lighting control protocol, such as a digital addressable lighting interface (DALI) or ZigBee protocol. In one embodiment, the frame control signal 366 is a photonic signal in the frequency range from infrared to ultraviolet light. In an alternative embodiment, the frame control signal 366 is a radio signal. In another alternative embodiment, the frame control signal 366 is a power line signal. In another alternative embodiment, the frame control signal 366 is wired to the signal source and the frame control signal 366 is a wired signal.

The processor 300 can be communicatively coupled by input/output signal 362 to one or more input/output interfaces. In one embodiment, the processor 300 is communicatively coupled to a digital camera interface 318 for downloading digital pictures from a digital camera into the memory 316. In another embodiment, the processor 300 is communicatively coupled to a digital memory card interface 320 for downloading digital pictures stored on a digital memory card into the memory 316. In another embodiment, the processor 300 is communicatively coupled to a modem 322 for enabling Internet access for downloading user selected digital picture from an Internet server into the memory 316. In another embodiment, the processor 300 is communicatively coupled to a printer interface 324 for connection to a printer, permitting the user to print digital pictures stored in the memory 316. The light control picture frame 100 can include any one or any combination of the interfaces described.

FIG. 4 is a flow chart of a method of selecting a light control picture frame mode for a light control picture frame made in accordance with the present invention. The user selects a light control picture frame mode 402. When it is determined that the selected light control picture frame mode is a picture display mode 404, a picture is displayed in the picture frame display 406. When it is determined that the selected light control picture frame mode is the display control mode 408, the light control picture frame is placed in the display control mode, and the user can exercise display control options 410. When it is determined that the selected light control picture frame mode is the light control mode 414, the light control picture frame is placed in light control mode, and the user can exercise light control options 416. Once the user has completed exercising the desired options, the light control picture frame is placed in the picture display mode 412.

The user can place the light control picture frame in one of three modes: the picture display mode, the display control mode, or the light control mode. In the picture display mode, a digital picture is displayed on the picture frame display. In the display control mode, the user can alter one or more options associated with the digital picture to be displayed on the picture frame display. In the light control mode, the user can select options that control a light unit. In one embodiment, the user selects a light control picture frame mode using the user input device. The user input device generates a user input signal identifying the selected light control picture frame mode. The light controller receives the user input signal and coordinates operation with the display controller to display the desired visual information on the picture frame display.

When it is determined that the selected light control picture frame mode is a picture display mode 404, a picture is displayed in the picture frame display 406. Typically, the picture is retrieved from memory, having been previously stored in memory by the manufacturer and/or the user. In one embodiment, a number of pictures have been stored in memory and the user has the option of marking one or more digital pictures with display flags. The flagged pictures are displayed in the picture frame display, such as in a slide show format. The display time for each picture can be a predefined time, such as a user defined time. In an alternative embodiment, the display time for each picture can be a random time. The display order can be sequential as stored in the memory, a user defined order, a random order, or the like. When no digital picture is flagged, the picture frame display can display a default digital picture, or a digital picture from a default memory address.

When it is determined that the selected light control picture frame mode is the display control mode 408, the light control picture frame is placed in the display control mode, and the user can exercise display control options 410. The display control options include defining picture frame display parameters, downloading digital pictures, and/or selecting one or a number of digital pictures for display. Typically, a display options menu is displayed on entering the display control mode permitting the user to choose from the available display options.

When the user selects the option of defining picture frame display parameters from the display options menu, a listing of the available display options is provided in a display parameters menu. The available display parameter options can include display contrast, display brightness, display sharpness, display tint, display color, and the like. The ranges of the selected display parameter are displayed and the user selects specific settings for each of the selected display parameters.

When the user selects the option of downloading digital pictures into memory from an external source, the user is guided through the steps necessary to perform the download. In various embodiments, the user can download digital pictures from a digital camera, a digital memory card, an Internet server, or any other source for digital pictures. In an alternative embodiment, the digital pictures are supplied by the manufacturer and no downloading option is required.

When the user selects the option of selecting a digital picture for display, a digital picture index is displayed. The digital picture index includes digital pictures stored in the memory that are available for display. In one embodiment, the digital picture index is an alphanumeric listing of the all of the available digital pictures. In another embodiment, the digital picture index is a display of thumbnail images of the digital pictures. The user flags one or a number of digital pictures from the digital picture index for display.

When the user exits the display control mode, the light control picture frame is placed in the picture display mode 412 and the flagged digital pictures are displayed in a single or slideshow format.

When it is determined that the selected light control picture frame mode is the light control mode 414, the light control picture frame is placed in light control mode, and the user can exercise light control options 416. The light control options include adjusting the color and/or adjusting the intensity settings for the light unit. The method of controlling a light unit is described in connection with FIG. 5 below. When the user exits the display control mode, the light control picture frame is placed in the picture display mode 412 and the flagged digital pictures are displayed in a single or slideshow format.

Those skilled in the art will appreciate that the determination of the picture frame mode as the picture display mode, display control mode, or light control mode can be made in any order desired, and that more or fewer picture frame modes can be included as desired.

FIG. 5 is a flow chart of a method of controlling a light unit using a light control picture frame made in accordance with the present invention. A picture frame display is provided 502 and a color index displayed on the picture frame display 504. The user selects a color scheme from the color index 506 and a light control signal is generated in response to the color scheme 508.

At 502, a picture frame display is provided. The picture frame display is any display capable of displaying visual information and is part of a light control picture frame.

At 504, a color index is displayed on the picture frame display. In one embodiment, the color index is displayed as part of the light control mode. The color index provides color schemes available for selection by the user. The color index can be a color list, a color wheel, a color picker, a sampled picture display, a picture sampling display, or the like. In one embodiment, the color scheme is generated by sampling the picture or portion of the picture displayed. The color index is discussed further in connection with FIG. 6 below. In one embodiment, the color index also includes an intensity index, allowing selection of the intensity for the light unit. For example, the color index can be presented at different brightnesses on the picture frame display or a control slider on the picture frame display can adjust the displayed color index brightness.

At 506, the user selects a color scheme from the color index.

At 508, a light control signal is generated in response to the color scheme selected. The light control signal is provided to the light unit to control the color, brightness, and/or intensity of the light produced consistent with the color scheme selected.

In one embodiment, the light control signal can be generated from a picture. A picture is provided and at least one characteristic of the picture is sampled. Examples of characteristics include color, brightness, intensity, hue, saturation, luminosity, or the like. The light control signal is generated in response to the characteristic.

FIGS. 6A-6E are schematic diagrams of color indexes for a light control picture frame made in accordance with the present invention. The color indexes provide graphical displays from which the user selects a token associated with a color scheme. The color index can be a color list, a color wheel, a color picker, a sampled picture display, picture sampling display, or the like.

In FIG. 6A, the color index 600 displayed on the picture frame display 304 is a color list. In the example shown, the color index 600 includes alphanumeric tokens 602 and graphic tokens 604. The alphanumeric tokens 602 can be a list of color names (red, blue, green, etc.) or a list of words (summer, spring, Indian summer, seaside, etc.), each being associated with a particular color scheme. The graphic tokens 604 can display individual colors or can be images, such as thumbnails, each being associated with a particular color scheme. Those skilled in the art will appreciate that the color index 600 can include either or both the alphanumeric tokens 602 and the graphic tokens 604.

In FIG. 6B, the color index 600 displayed on the picture frame display 304 is a color wheel. In the example shown, the color index 600 includes wheel tokens 606 displaying individual colors. Each wheel token 606 is associated with a particular color scheme. The arc of each wheel tokens 602 can be small, so that the color transition around the color wheel appears continuous to the user.

In FIG. 6C, the color index 600 displayed on the picture frame display 304 is a color picker. In the example shown, the color index 600 includes segment tokens 608 displaying individual colors. Each segment tokens 608 is associated with a particular color scheme. The size of each segment tokens 608 can be small, so that the color transition across the color picker appears continuous to the user.

In FIG. 6D, the color index 600 displayed on the picture frame display 304 is a sampled picture display. In the example shown, the color index 600 includes sampled picture tokens 610 displaying sampled pictures. Characteristics of each picture, such as color, brightness, intensity, hue, saturation, luminosity, or the like, are sampled and a color scheme calculated for each picture. When the user selects a sampled picture token 610, the light unit adjusts the light to match the associated color scheme. For example, when the sampled picture token 610 selected is a bright beach picture showing blue sky, blue ocean, and yellow sand, the light unit is set to bright with colors of blue and yellow in accordance with the sampling results for the picture. In another example, when the sampled picture color scheme 610 selected is a subdued fall scene showing orange leaves and brown grass, the light unit is set to low with colors of orange and brown in accordance with the sampling results for the picture.

In FIG. 6E, the color index 600 displayed on the picture frame display 304 is a picture sampling display. In the example shown, the color index 600 includes a picture 612 with sampling portion 614. The user selects a picture 612 for sampling and establishes boundaries of the sampling portion 614 by moving a cursor or finger around the screen. In an alternative embodiment, the user points to a portion of the screen and the light control picture frame establishes the boundaries of the sampling portion 614. The boundaries of the sampling portion 614 can be displayed on the picture frame display 304 or can be hidden. On action by the user, such as clicking on the sampling portion 614, or after the boundaries of the sampling portion 614 are held constant a predetermined time, the characteristics of the portion of the picture in the sampling portion 614 are sampled and a color scheme calculated for the sampling portion 614. Examples of characteristics include color, brightness, intensity, hue, saturation, luminosity, or the like. The light unit adjusts the light to match the color scheme associated with the sampling portion 614. In one embodiment, the user can name and save the color scheme for later use, such as an alphanumeric token in a color list as discussed for FIG. 6A above.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced within.

1. A light control picture frame comprising:
a processor 300, the processor 300 being responsive to a user input signal 350, generating a display signal 352, and generating a transmitter signal 354;
a picture frame display 304, the picture frame display 304 being responsive to the display signal 352;
a user input device 312, the user input device 312 generating the user input signal 350 responsive to a user; and
a light signal transmitter 308, the light signal transmitter 308 being responsive to the transmitter signal 354.

2. The light control picture display of claim 1 wherein the processor 300 comprises:
a display controller 302, the display controller 302 being responsive to the user input signal 350, generating the display signal 352, and generating a color scheme signal 360; and
a light controller 306, the light controller 306 being responsive to the color scheme signal 360 and generating the transmitter signal 354.

3. The light control picture display of claim 2 wherein the display controller 302 has a sampler 314, the sampler 314 generating the color scheme signal 360 responsive to at least a portion of a picture.

4. The light control picture display of claim 1 wherein the picture frame display 304 is selected from the group consisting of a liquid crystal display, an e-ink display, an organic light-emitting diode display, a polymer light-emitting diode display, a touch screen display, a resistive touch screen display, a capacitive touch screen display, and a surface acoustic wave touch screen display.

5. The light control picture display of claim 1 wherein the picture frame display 304 is responsive to the display signal 352 to display a color-index, the color index being selected from the group consisting of a color list, a color wheel, a color picker, a sampled picture display, and a picture sampling display.

6. The light control picture display of claim 1 wherein the user input device 312 is selected from the group consisting of a cursor control 326, an option selection control 328, and a mode selection control 310.

7. The light control picture display of claim 1 wherein the user input device 312 is the picture frame display 304.

8. The light control picture display of claim 1 further comprising a memory 316 operably connected to the processor 300.

9. The light control picture display of claim 1 wherein the processor 300 further comprises a sampler 314 for determining a color scheme.

10. The light control picture display of claim 1 wherein the light control signal 105 is selected from the group consisting of a photonic signal, a radio wave signal, power line signal, and a wired signal.

11. The light control picture display of claim 1 further comprising an interface selected from the group consisting of a digital camera interface 218, a digital memory card interface 220, a modem 222, and a printer interface 224.

12. The light control picture display of claim 1 further comprising a frame receiver 330 responsive to a frame control signal 366 and generating a receiver signal 364, the receiver signal 364 being provided to the processor 300.

13. A method of light unit control, the method comprising:
providing a picture frame display 502;
displaying a color index on the picture frame display 504;
selecting a color scheme from the color index 506; and
generating a light control signal in response to the color scheme 508.

14. The method of claim 13 wherein the providing a picture frame display 502 comprises providing a picture frame display selected from the group consisting of a liquid crystal display, an e-ink display, an organic light-emitting diode display, a polymer light-emitting diode display, a touch screen display, a resistive touch screen display, a capacitive touch screen display, and a surface acoustic wave touch screen display.

15. The method of claim 13 wherein the displaying a color index on the picture frame display 504 comprises displaying a color index selected from the group consisting of a of a color list, a color wheel, a color picker, a sampled picture display, and a picture sampling display.

16. The method of claim 13 further comprising selecting a light control picture frame mode 402 and displaying a picture on the picture frame display when the light control picture frame mode is a picture display mode 406.

17. The method of claim 16 further comprising displaying light control options on the picture frame display when the light control picture frame mode is a light control mode.

18. The method of claim 16 further comprising displaying display control options on the picture frame display when the light control picture frame mode is a display control mode.

19. The method of claim 13 wherein the color index is a picture sampling display and the selecting a color scheme from the color index 506 comprises selecting at least a portion of the picture sampling display and generating the color scheme from the portion of the picture.

20. The method of claim 13 further comprising storing pictures in memory.

21. The method of claim 20 further comprising flagging certain of the pictures for display on the picture frame display.

22. The method of claim 21 further comprising displaying the flagged pictures in a slide show format.

23. A system of light unit control, the system comprising:
a picture frame display;
means for displaying a color index on the picture frame display;
means for selecting a color scheme from the color index; and
means for generating a light control signal in response to the color scheme.

24. The system of claim 23 further comprising means for selecting a light control picture frame mode and means for displaying a picture on the picture frame display when the light control picture frame mode is a picture display mode.

25. The system of claim 23 further comprising means for displaying light control options on the picture frame display when the light control picture frame mode is a light control mode.

26. The system of claim 23 further comprising means for displaying display control options on the picture frame display when the light control picture frame mode is a display control mode.

27. The system of claim 23 wherein the color index is a picture sampling display and the means for selecting a color scheme from the color index comprises means for selecting at least a portion of the picture sampling display and means for generating the color scheme from the portion of the picture.

28. The system of claim 23 further comprising means for storing pictures.

29. The system of claim 28 further comprising means for flagging certain of the pictures for display on the picture frame display.

30. The system of claim 29 further comprising means for displaying the flagged pictures in a slide show format.

31. A method of controlling a light unit comprising:
providing a picture;
sampling a characteristic of the picture; and
generating a light control signal in response to the characteristic.

32. The method of claim 31 wherein the characteristic is selected from the group consisting of color, brightness, intensity, hue, saturation, and luminosity.
